(19) United States
(12) Patent Application Publication
(10) Pub. No.: US 2013/0137311 A1
(43) Pub. Date: May 30, 2013

(54) CONNECTOR ASSEMBLY

(71) Applicants: HSIAO-PING HSUEH, Tu-Cheng (TW); YU-CHI TSAI, Tu-Cheng (TW)

(72) Inventors: HSIAO-PING HSUEH, Tu-Cheng (TW); YU-CHI TSAI, Tu-Cheng (TW)

(73) Assignee: HON HAI PRECISION INDUSTRY CO., LTD., Tu-Cheng (TW)

(21) Appl. No.: 13/526,583

(22) Filed: Jun. 19, 2012

(30) Foreign Application Priority Data
Nov. 30, 2011 (TW) 100144079

(51) Int. Cl. H01R 24/76

(52) U.S. Cl. 439/668

(57) ABSTRACT

A connector assembly includes a jack formed on a circuit board and a plug engaging with the jack. The jack includes a main hole and at least one fool-proof hole extending from a periphery of the main hole. The plug includes a main connecting part corresponding to the main hole and at least one fool-proof part extending from a periphery of the main connecting part. When the plug is inserted into the jack, the main connecting part is tightly received in the main hole, and the at least one fool-proof part is tightly received in the at least one fool-proof hole.

### TECHNICAL FIELD

The disclosure generally relates to connector assemblies.

### DESCRIPTION OF RELATED ART

Many connector assemblies include a plug and a jack for receiving the plug. For an electrical device, many connector assemblies may be used for transmitting many signals. However, some of the jacks on a circuit board of the electrical device may be similar to each other in shapes and sizes. Thus, a user or an operator may insert a plug into a wrong jack, which will waste time when solving misoperations.

Therefore, it is desirable to provide a connector assembly which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a connector assembly in accordance with a first embodiment of present disclosure.

FIG. 2 is an isometric view of a connector assembly in accordance with a second embodiment of present disclosure.

FIG. 3 is an isometric view of a connector assembly in accordance with a third embodiment of present disclosure.

FIG. 4 is an isometric view of a connector assembly in accordance with a fourth embodiment of present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

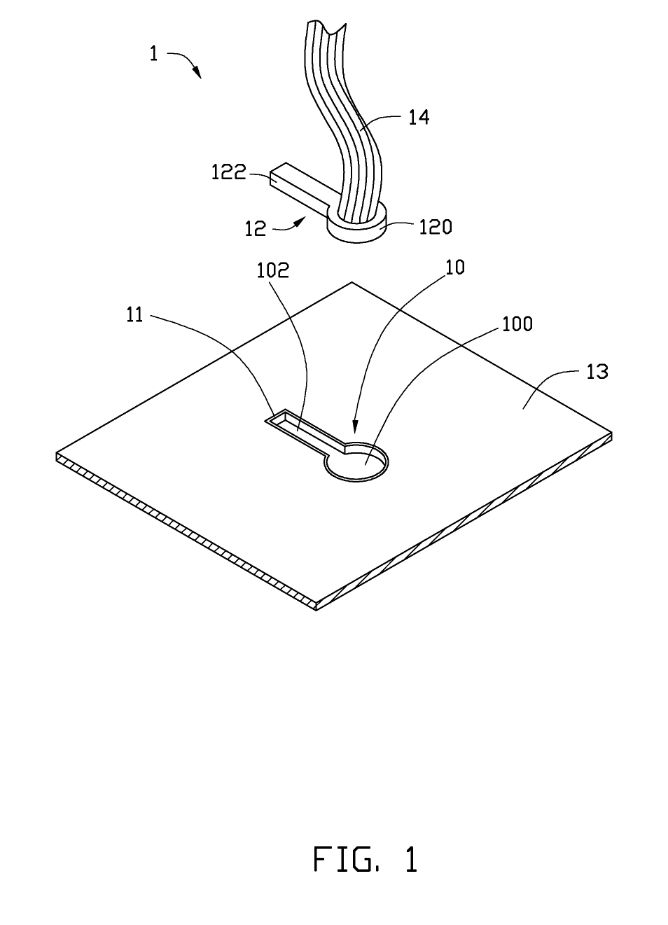

FIG. 1, is a connector assembly 1 in accordance with a first embodiment of the present disclosure. The connector assembly 1 includes a jack 10, a conducting strip 11, and a plug 12. The jack 10 is defined in a circuit board 13. The conducting strip 11 is formed on an inner surface of the jack 10 to receive an electrical signal. The plug 12 is formed at a distal end of an electrical wire 14. The plug 12 engages with the jack 10 to transmit the electrical signal from the electrical wire 14 to the circuit board 13 via the conducting strip 11.

The jack 10 includes a main hole 100 and at least one fool-proof hole 102 communicating with the main hole 100. The plug 12 includes a main connecting part 120 and at least one fool-proof connecting part 122 extending from a periphery of the main part 120. When the plug 12 is inserted into the jack 10, the main connecting part 120 is tightly received in the main hole 100, and the fool-proof connecting part 122 is tightly received in the fool-proof hole 102. The main hole 100 can be circular, elliptical, or polygonal. The fool-proof hole 102 can be rectangular. In this embodiment, the main hole 100 is circular in shape. The fool-proof hole 102 is a rectangular hole extending from a periphery of the main hole 100 along a radial direction of the main hole 100. The main connecting part 120 is a circular cylinder. The fool-proof connecting part 122 is a first rectangular pillar. The length of the first rectangular hole 102 is the same as the length of the first rectangular pillar 122.

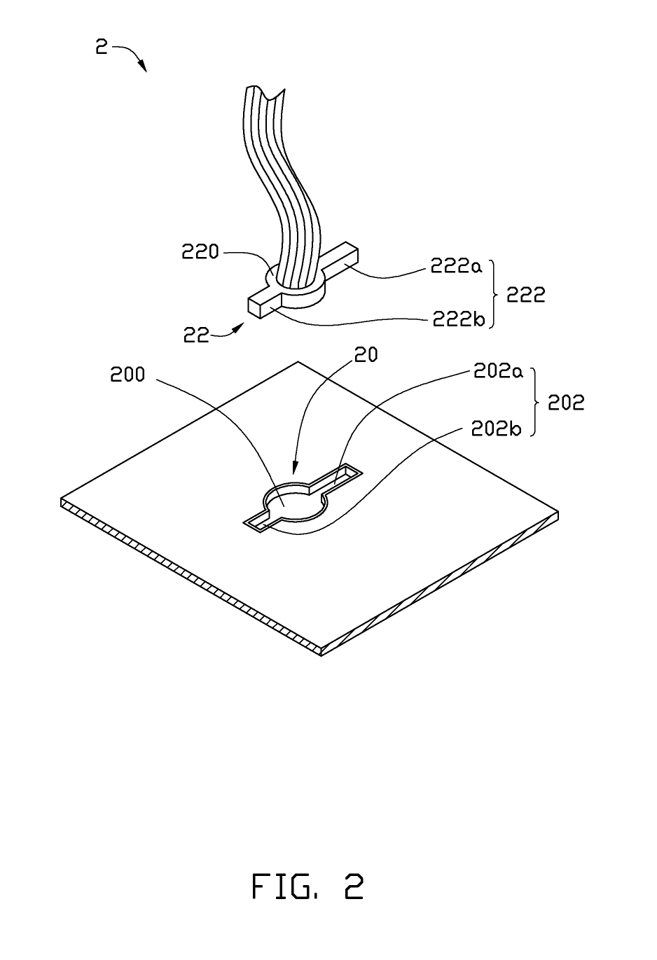

FIG. 2, illustrates a connector assembly 2 in accordance with a second embodiment of the present disclosure. The connector assembly 2 is similar to the connector assembly 1 of the first embodiment in structure except that the jack 20 includes two fool-proof holes 202 and the plug 22 includes two fool-proof connecting parts 222. The fool-proof holes 202 includes a second rectangular hole 202a and a third rectangular hole 202b. The second rectangular hole 202a and the third rectangular hole 202b respectively extend from two opposite positions on a periphery of the main hole 200. These two opposite positions are symmetrical distributed about a center of the main hole 200. The length of the second rectangular hole 202a is greater than the length of the third rectangular hole 202b. Correspondingly, the fool-proof connecting parts 222 include a second rectangular pillar 222a and a third rectangular pillar 222b. The length of the second rectangular pillar 222a is the same as the length of the second rectangular hole 202a. The length of the third rectangular pillar 222b is the same as the length of the third rectangular hole 202b.

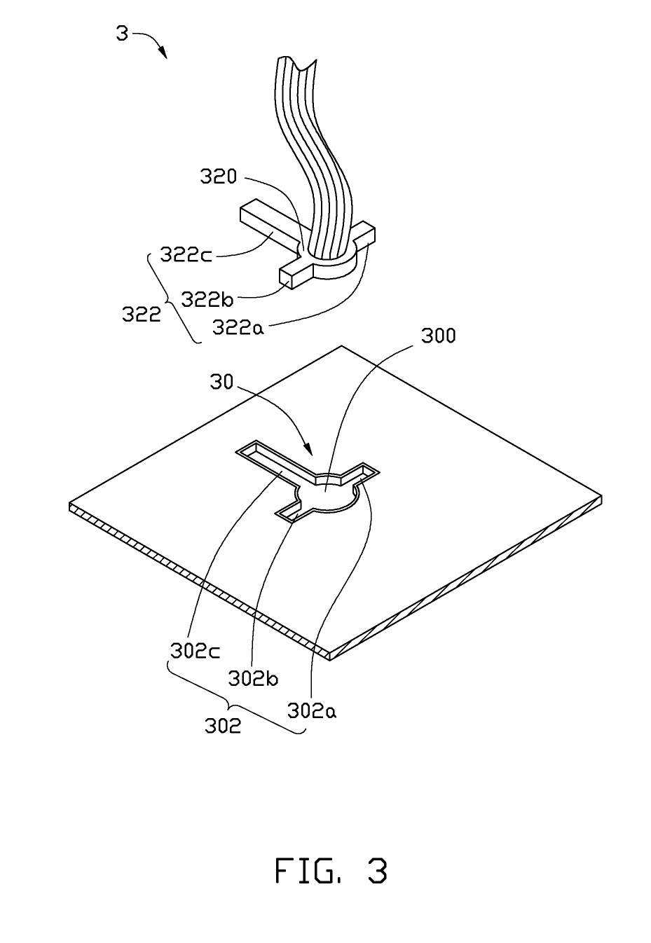

FIG. 3, illustrates a connector assembly 3 in accordance with a third embodiment of the present disclosure. The connector assembly 3 is similar to the connector assembly 2 of the second embodiment in structure except that the jack 30 includes three fool-proof holes 302 and the plug 300 includes three fool-proof connecting parts 322. The fool-proof holes 302 include a fourth rectangular hole 302a, a fifth rectangular hole 302b, and a sixth rectangular hole 302c. The fourth rectangular hole 302a and the fifth rectangular hole 302b respectively extend from two opposite positions on a periphery of the main hole 300. This two opposite positions are symmetrical distributed about a center of the main hole 300. The sixth rectangular hole 302c extends from the periphery of the main hole 300 along a direction perpendicular to the longitudinal direction of the fourth rectangular hole 302a and the fifth rectangular hole 302b. The length of the fourth rectangular hole 302a is different from the length of the second rectangular hole 202a of the second embodiment. The length of the fifth rectangular hole 302b is different from the length of the third rectangular hole 202b of the second embodiment. The length of the sixth rectangular hole 302c is different from the length of the first rectangular hole 102 of the first embodiment. Correspondingly, the fool-proof connecting parts 322 includes a fourth rectangular pillar 322a, a fifth rectangular pillar 322b, and a sixth rectangular pillar 322c. The length of the fourth rectangular pillar 322a is the same as the length of the fourth rectangular hole 302a. The length of the fifth rectangular pillar 322b is the same as the length of the fifth rectangular hole 302b. The length of the sixth rectangular pillar 322c is the same as the length of the sixth rectangular hole 302c.

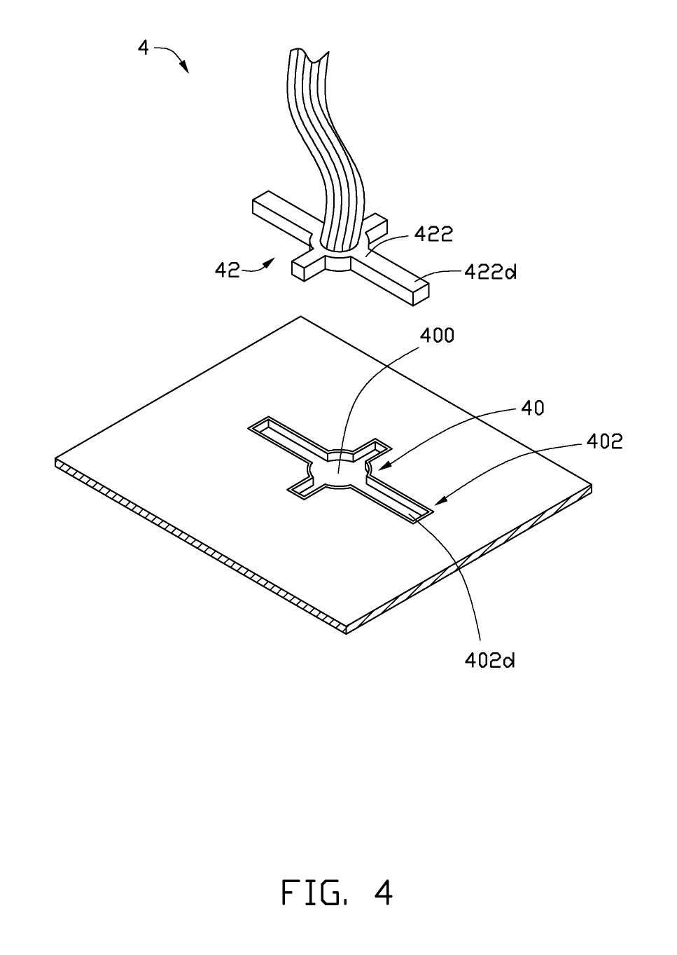

FIG. 4, illustrate a connector assembly 4 in accordance with a fourth embodiment of the present disclosure. The connector assembly 4 is similar to the connector assembly 3 of the third embodiment in structure except that the fool-proof holes 402 of the jack 40 further include a seventh rectangular hole 402d and the fool-proof connecting parts 422 of the plug 42 further include a seventh rectangular pillar 422d corresponding to the seventh rectangular hole 402d. The seventh rectangular hole 402d extends from the periphery of the main hole 400 along an direction inverse to the longitudinal direction of the sixth rectangular hole 302c. The length of the seventh rectangular hole 402d is different from the length of the sixth rectangular hole 302c. The length of the seventh rectangular pillar 422d is the same as the length of the seventh rectangular hole 402d.

In an alternative embodiment, a distal end of each of the fool-proof holes 102, 202, 302, or 402 is circular.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A connector assembly, comprising:
at least one jack, each jack defining a main hole and at least one fool-proof hole communicating with a periphery of the main hole; and
at least one plug correspondingly engaging with the jack, each plug comprising a main connecting part corresponding to the main hole and at least one fool-proof part extending from a periphery of the main connecting part;
wherein when the plug inserts into the jack, the main connecting part is tightly received in the main hole, and the at least one fool-proof part is tightly received in the at least one fool-proof hole.

2. The connector assembly of claim 1, wherein the shape of the main hole and the main connecting part is selected from a group consisting of a circle, an ellipse, and a polygon.

3. The connector assembly of claim 1, wherein the fool-proof hole and the fool-proof part are rectangular in shape.

4. The connector assembly of claim 1, wherein the main hole is circular in shape, the connector assembly comprises a first jack comprising one fool-proof hole, the fool-proof hole is a first rectangular hole extending from a periphery of the main hole along a radial direction of the main hole.

5. The connector assembly of claim 4, wherein the connector assembly comprises a first plug comprising one fool-proof connecting part, the main connecting part of the first plug is a circular cylinder, the fool-proof connecting part is a first rectangular pillar corresponding to the first rectangular hole, the length of the first rectangular hole is the same as the length of the first rectangular pillar.

6. The connector assembly of claim 4, wherein the connector assembly comprises a second jack comprising a pair of the fool-proof holes, the fool-proof holes comprise a second rectangular hole and a third rectangular hole, the second rectangular hole and the third rectangular hole respectively extend from two opposite positions on a periphery of the main hole symmetrical distributed about a center of the main hole, the length of the second rectangular hole is greater than the length of the third rectangular hole, the length of the second rectangular hole is less that the length of the first rectangular hole.

7. The connector assembly of claim 6, wherein the connector assembly comprises a second plug comprising a pair of the fool-proof connecting parts, the fool-proof connecting parts comprise a second rectangular pillar corresponding to the second rectangular hole and a third rectangular pillar corresponding to the third rectangular hole, the length of the second rectangular pillar is the same as the length of the second rectangular hole, the length of the third rectangular pillar is same as the length of the third rectangular hole.

8. The connector assembly of claim 6, wherein the connector assembly comprises a third jack comprising three fool-proof holes, the fool-proof holes comprise a fourth rectangular hole, a fifth rectangular hole, and a sixth rectangular hole, the fourth rectangular hole and the fifth rectangular hole respectively extend from two opposite positions on a periphery of the main hole symmetrical distributed about a center of the main hole, the sixth rectangular hole extends from the periphery of the main hole along a direction perpendicular to the longitudinal direction of the fourth rectangular hole and the fifth rectangular hole, the length of the fourth rectangular hole is different from the length of the second rectangular hole, the length of the fifth rectangular hole is different from the length of the third rectangular hole, the length of the sixth rectangular hole is different from the length of the first rectangular hole.

9. The connector assembly of claim 8, wherein the connector assembly comprises a third plug comprising three fool-proof connecting parts, the fool-proof connecting parts comprises a fourth rectangular pillar corresponding to the fourth rectangular hole, a fifth rectangular pillar corresponding to the fifth rectangular hole, and a sixth rectangular pillar corresponding to the sixth rectangular hole, the length of the fourth rectangular pillar is the same as the length of the fourth rectangular hole, the length of the fifth rectangular pillar is the same as the length of the fifth rectangular hole, and the length of the sixth rectangular pillar is the same as the length of the sixth rectangular hole.

10. The connector assembly of claim 8, wherein the connector assembly comprises a fourth jack comprising four fool-proof holes, the fool-proof holes further comprises a seventh rectangular hole, the seventh rectangular hole extend from the periphery of the main hole along an direction inverse to the longitudinal direction of the sixth rectangular hole, the length of the seventh rectangular hole is different from the length of the sixth rectangular hole.

11. The connector assembly of claim 10, wherein the connector assembly comprises a fourth plug comprising four fool-proof connecting parts, the fool-proof connecting parts further comprises a seventh rectangular pillar corresponding to the seventh rectangular hole, the length of the seventh rectangular pillar is the same as the length of the seventh rectangular hole.
